(19) United States
(12) Patent Application Publication
(10) Pub. No.: US 2015/0143879 A1
(43) Pub. Date: May 28, 2015

(54) Vacuum Actuated Duct Test Plug with Pressure Test Tube

(71) Applicant: Kirk Johnson, Downers Grove, IL (US)

(72) Inventor: Kirk Johnson, Downers Grove, IL (US)

(21) Appl. No.: 14/553,816

(22) Filed: Nov. 25, 2014

Related U.S. Application Data
(60) Provisional application No. 61/908,579, filed on Nov. 25, 2013.

(51) Int. Cl. G01M 99/00

(52) U.S. Cl. CPC G01M 99/008
USPC 73/49.8

(57) ABSTRACT

A vacuum actuated duct test plug with pressure test tube comprising a compressible foam block mounted to an elongate hollow tube and plastic enclosure having an open end wherein a vacuum applied to the open end of the plastic enclosure evacuates air from the enclosure and compresses the block allowing it to be placed into a duct register boot, and expands to create an air tight seal when the vacuum is withdrawn from the enclosure. Pressure behind the plug can be tested at the end of the hollow tube.

### CLAIM OF PRIORITY

This patent application claims priority under 35 USC 119 (e) (1) from U.S. Provisional Patent Application Serial Number 61/908,579 filed Nov. 25, 2013, of common inventorship herewith entitled, “Vacuum Actuated Duct Test Plug with Pressure Test Tube,” which is incorporated herein by reference as though the same were set forth in its entirety.

### FIELD OF THE INVENTION

The present invention pertains to the field of HVAC devices, and more specifically to the field of duct testing apparatuses.

### BACKGROUND OF THE INVENTION

The prior art has put forth several designs for duct testing devices. Among these are:

US Patent Publication 2012/0273073 to Kyle Kutach describes a duct plug inflatable safety device. This device is used in an overhead conduit or area of cement manufacturing plant to prevent debris from falling on a worker below.

U.S. Design Pat. D683,441 to Gianni Simone provides a design for a ventilation duct plug.

U.S. Pat. No. 3,451,432 to Daniel R. Miller provides a test plug means for fluid conduits wherein the test plug removably closes an access opening through which a measuring instrument may be inserted.

None of these prior art references describe the present invention.

### SUMMARY OF THE INVENTION

It is an object of the present invention to provide a vacuum actuated duct test plug.

It is a further object of the present invention to provide a vacuum actuated duct test plug with pressure test tube.

### BRIEF DESCRIPTION OF THE DRAWINGS

FIG. 1 is a schematic view of the device of the present invention showing a foam block with a hollow tube attached thereto and a pressure tap at the distal end of the tube and a 3 mil thick plastic enclosure surrounding the foam block. In an embodiment, adhesive can be applied to the top of the plastic enclosure to accurately position the block.

FIG. 2 is a diagrammatic representation showing the compressed foam block when vacuum is applied to the device through the pressure tap at the distal end of the hollow tube.

FIG. 3 shows the plug in place, and the vacuum removed.

### DETAILED DESCRIPTION OF THE INVENTION

The present invention, hereinafter referred as the vacuum actuated duct test plug with pressure test tube, or simply duct test plug. The device provides a temporary air duct sealing device which is used when pressure testing ductwork to meet new energy codes. The device 10, comprises a compressible foam block 12 attached to the proximal end of an elongate hollow tube 16 and compressible foam block 12 is surrounding by a plastic enclosure 14, wherein the plastic enclosure 14 has an open end capable of having a vacuum applied to its open end. In an embodiment, the plastic enclosure 14 comprises 3 mil thick plastic. When a vacuum is applied to the open end of the plastic enclosure 14, air is evacuated from the plastic enclosure 14 and block 12 compresses, allowing the user to insert the block into a duct register boot 20. When the vacuum is removed, the block 12 expands, creating an airtight seal in the duct register boot 20. The hollow tube extends into the duct allowing the pressure behind the plug to be tested, to comply with new required energy codes. The pressure is behind the plug is tested by means of the pressure tap 18 mounted to the distal end of the elongate hollow tube 16.

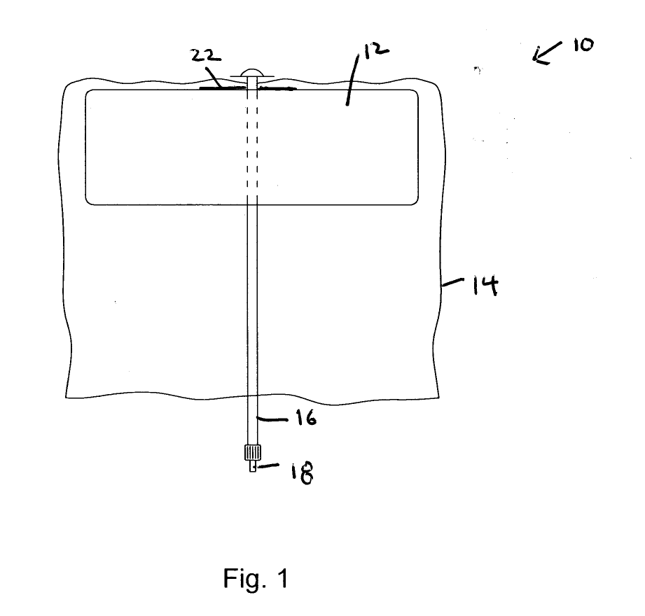

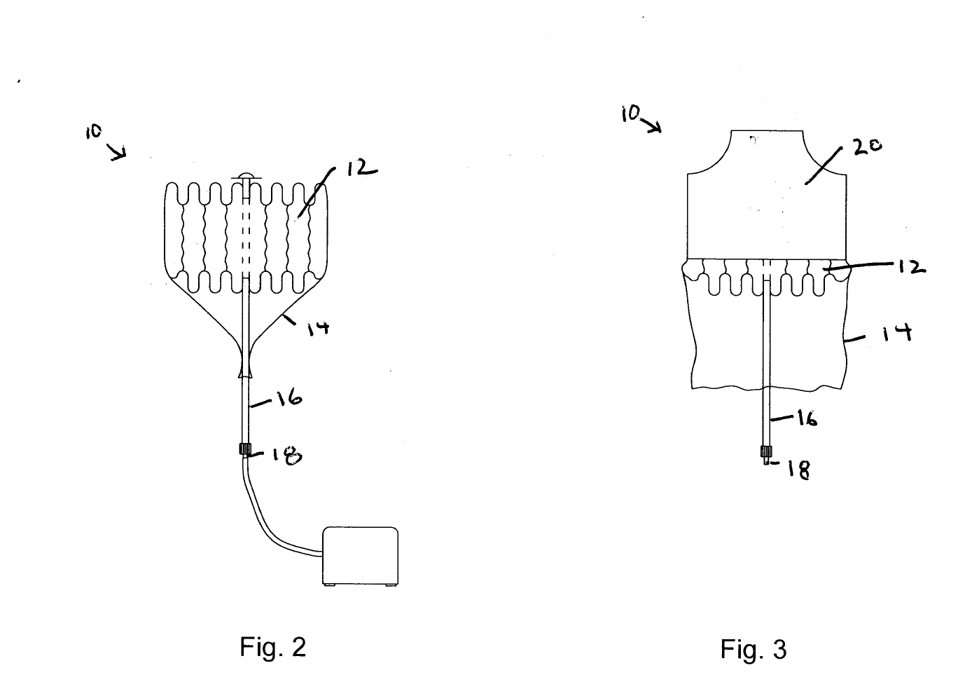

FIG. 1 shows the block 12 in its expanded state. FIGS. 2 and 3 show the block 12 in its compressed state. FIG. 3 further shows the block 12 in its compressed state inserted into a duct register boot 20.

In an embodiment, adhesive 22 can be applied to the block to facilitate positioning of the block inside the enclosure. Any suitable adhesive can be used, such as isotactic polyproplyene, for example.

Use of the device of the present invention allows pressure to be checked at each register boot. Additionally, the duct test plug of the present invention can be used in overhead application without the use of a ladder, thereby avoiding the hazards concomitant with elevated work environments.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A duct test plug device comprising: a hollow tube having a distal end and a proximal end; and a compressible foam block attached to the proximal end of the hollow tube and the block is surrounded by a plastic enclosure having an open end, wherein a vacuum applied to the open end of the plastic enclosure evacuates air from the enclosure and compresses the foam block, allowing the foam block to be inserted into a duct register boot, and wherein the block expands expands to create an airtight seal in the duct register boot when the vacuum is withdrawn from the enclosure.

2. The duct test plug of claim 1 further comprising a pressure tap at the distal end of the hollow tube allowing measurement of the pressure behind the duct test plug to be measured.

3. The duct test plug of claim 1 further comprising adhesive applied to the block to facilitate positioning of the block inside the enclosure.

4. The duct test plug of claim 2 further comprising adhesive applied to the block to facilitate positioning of the block inside the enclosure.

5. The duct test plug of claim 1 wherein the plastic enclosure is 3 mil thick plastic.

6. The duct test plug of claim 2 wherein the plastic enclosure is 3 mil thick plastic.
